(19) United States
(12) Patent Application Publication
(10) Pub. No.: US 2011/0036372 A1
(43) Pub. Date: Feb. 17, 2011

(54) USE OF CITRATE AS CLEANING AID FOR HARD SURFACES

(76) Inventor: Thomas Stirling, Bebington (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/935,290

(22) PCT Filed: Mar. 5, 2009
(86) PCT No.: PCT/EP09/52592

§ 371 Date: Nov. 3, 2010

(30) Foreign Application Priority Data
Apr. 4, 2008 (EP) 08154049.4

(51) Int. Cl. B08B 1/00; C11D 1/04; B08B 7/00

(52) U.S. Cl. 134/4; 510/365; 510/234; 510/238; 510/245; 510/239

(57) ABSTRACT

The present invention relates to hard surface cleaning, and has as an object to provide a next time cleaning benefit. The invention provides the use of citric acid and/or a salt of citric acid for facilitating the removal of soil, in particular fatty soil, from a hard surface. Therewith the object of the invention has been achieved.

The present invention relates to the use of citric acid and/or a salt of citric acid in cleaning compositions for cleaning hard surfaces, to obtain a next time cleaning benefit. Moreover the invention relates to a method for cleaning hard surfaces.

Hard surfaces in the home or office are usually cleaned using liquid compositions which comprise one or more surfactants and possibly also pH adjusters like citric acid or sodium salts of citrate. The cleaning compositions can be applied in diluted (in water) or undiluted form, in a spray, or rubbed using a cloth and any other convenient way. Optionally the cleaning composition may be rinsed from the surface after the cleaning. It would be advantageous if the hard surface to be cleaned could be treated with a material which would assist in easier removal of soil and/or stains during subsequent cleaning. This is referred to as the next time cleaning benefit.

Soils on hard surfaces can become more difficult to remove when not cleaned soon after deposition. When not cleaned promptly, soils can become more adherent to surfaces, more viscous and generally tougher, and require more effort to clean. While not being bound by theory, this more difficult removal of soils can arise from the effects of drying out of soils, from chemical changes in soils, from reactions of soils with environmental agents such as oxygen, etc. Some soils are more susceptible than others to toughening reactions and processes. Soils comprising or containing chemically unsaturated oils and fats can become very tough and difficult to clean over time, especially when exposed to elevated temperatures. Even light can cause such fatty soils to toughen over time. As well as environmental factors, the processes of toughening of soils can be affected by the nature and composition of the surface on which the soil is located.

Hard-surface cleaning compositions may be either acidic or alkaline. Acidic compositions often contain carboxylic acids which may be mono-, di- or polycarboxylic acids, such as citric acid, sorbic acid, acetic acid, formic acid, maleic acid, adipic acid, lactic acid, malic acid and glycolic acid. Acidic cleaners are generally used for removing acid sensitive soil, such as limescale. For removal of fatty soil alkaline compositions are generally preferred.

WO 02/18531 discloses a method for cleaning hard surfaces, wherein the surface is treated with an antioxidant, followed by allowing the surface to become dirty, and subsequently cleaning the surface. The treatment of the surface with the antioxidant prior to the soiling, leads to easier removal of the soil during the subsequent cleaning step. The antioxidant may be present in a cleaning composition, or in a rinse composition that is applied after the cleaning. In addition cleaning compositions comprising antioxidants, preferably at a concentration of 0.1-10% by weight, are disclosed. Tannic acid was exemplified to be notably efficient. Citric acid may be used as metal ion sequestrant and if present it is present in combination with the antioxidant.

WO 03/07289 A1 discloses a method for removing fatty soil from a hard surface, the process comprising the sequential steps of (a) treating the hard surface with a liquid cleaning composition comprising a radical scavenging antioxidant and hydrogen peroxide; (b) allowing the fatty soil to deposit; and (c) cleaning the surface to remove the fatty soil. Preferably natural antioxidants are used in the process. liquid hard surface cleaning compositions comprising a natural radical scavenging antioxidant, hydrogen peroxide and preferably a surfactant are also disclosed. Tannic acid is the most preferred antioxidant of this disclosure.

WO 2006/108475 A1 discloses a method for removing soil or stains from a hard surface, the method comprising the steps in sequence of treating the surface with a malonic acid derivative, allowing the soil or stain to deposit and cleaning the surface to remove the soil or stains. Compositions and uses for said method are also disclosed. The method and composition provide an improved next time cleaning benefit, allowing easier removal of stains and soils upon a subsequent cleaning step. Citric acid is used for adjustment of the pH.

In spite of the advantages, the antioxidants as disclosed by the prior art also may suffer from disadvantages. When tannic acid is formulated into alkaline liquid cleaning compositions it produces aesthetically less-pleasing yellow-brown coloured solutions, and it may lead to browning of cement in joints between tiles. An antioxidant like malonic acid needs relatively high concentrations to achieve a next time cleaning benefit. Moreover consumers may regard residues of malonic acid on the hard surfaces in e.g. kitchen and bathroom to be harmful and undesired.

Accordingly it is an object of the present invention to achieve a next time cleaning benefit without the need of high concentrations of antioxidants in the compositions. A further objective is that the composition does not contain compounds which lead to undesired colouring of materials on which the composition is applied. It is yet another objective to achieve a next time cleaning benefit without leaving residues of compounds that can be considered to be harmful by the consumer.

We have now found that citric acid and citrates can be used for facilitating easier removal of soil from hard surfaces, at a surprisingly low concentration. After a surface has been treated with citric acid and/or a salt of citric acid, soils or stains subsequently deposited on that surface are more easily removed than without the previous treatment. This effect is generally referred to as ‘next time cleaning benefit’. This is especially notable on soils which experience toughening reactions and processes. The effect is notably experienced when the soil comprises fatty and/or oily dirt. Such dirt is often, although not exclusively, found on kitchen surfaces and surfaces associated with cooking.

Citric acid and citrates are known components of hard surface cleaning compositions. WO 02/18531 discloses combinations of citrate and antioxidants like polyphenols such as tannic acid. Moreover it is well known that citric acid and citrates function as builders and metal-ion sequestrants in liquid detergent compositions, as is disclosed by for example WO 02/18531, WO 2006/108475, and JP 2003-183698 A2. Citric acid may also be used for adjusting the pH of a hard surface cleaning composition, as disclosed in WO 2006/108475. This prior art however shows that the use of citric acid to adjust the pH does not provide a next time cleaning benefit.

GB 1 235 468 discloses a method for inhibiting corrosion of copper articles (e.g. cutlery) comprising contacting the article with an aqueous solution containing benzotriazole and citric acid or a salt thereof.

WO 96/26257 and WO 96/26260 disclose hard surface cleaning compositions comprising nonionic and cationic surfactants. The compositions are used for cleaning the surface and deposit thereupon a layer of cationic surfactant which assists the release of soil subsequently deposited upon the said surface. Citrates are exemplified as builders in these compositions.

WO 98/36042 discloses liquid hard-surface cleaners comprising dicapped (poly)alkoxylene glycols. The compositions provide next-time cleaning performance on hard-surfaces soiled by various soils, especially greasy type soils and/or burnt/sticky food residues. The compositions optionally contain citrates as builder.

Citric acid and citrates may also be used for prevention of the formation of scale or the removal of scale. WO 00/58228 discloses compositions for cleaning internal surface of boilers, heat exchangers, containing an inorganic reducing agent, a chelating agent (e.g. citric acid), a surfactant, and a dispersant. U.S. Pat. No. 6,265,781 B1 discloses solutions for cleaning polished aluminum-containing layers, comprising a corrosion-inhibiting agent, which may be citric acid or one of its salts. Citric acid may also be used for the prevention of lime deposits in toilets by incorporation in toilet rim blocks (H. G. Hauthal and G. Wagner (eds), ‘Household cleaning, care and maintenance products’, Verlag für chemische Industrie, 2004).

WO03/070872 and WO2006/136774 dislcose hard surface cleaning compositions having an acidic pH to remove soap scum and water stains. The compositions may comprise citric acid alone or in combination with an another acid. No next time cleaning benefit is disclosed.

This prior art shows that citric acid and it's salts are common ingredients of household cleaning products. However, none of the prior art discloses the use of citric acid and/or a salt of citric acid for obtaining a next time cleaning benefit.

Accordingly in a first aspect the present invention provides the use of citric acid and/or a salt of citric acid for facilitating the removal of soil, in particular fatty soil, from a hard surface, wherein the surface is treated with citric acid and/or a salt of citric acid prior to deposition of the soil.

In a second aspect the invention provides a method for removing soil or stains from a hard surface, the method comprising the sequential steps:
a) treating the surface with a cleaning composition comprising citric acid and/or a salt of citric acid at a concentration of between 0.05% by weight and 10% by weight.
b) allowing the soil or stain to deposit and toughen; and
c) cleaning the surface to remove the soil or stains.

### DETAILED DESCRIPTION

All percentages mentioned herein are by weight calculated on the total composition, unless specified otherwise. The abbreviation ‘wt %’ is to be understood as % by weight of the total composition.

The expressions ‘soil’ and ‘stain’ as used herein generally comprise all kinds of soils and stains generally encountered in the household, either of organic or inorganic origin, whether visible or invisible to the naked eye, including soiling solid debris and/or with bacteria or other pathogens. Specifically the method and compositions according to the invention may be used to treat surfaces susceptible to fatty or greasy soil and stains, more specifically those caused by natural fat or oil.

As used herein the phrase ‘citric acid and/or salt of citric acid’ is meant to include citric acid and salts of citric acid or mixtures of these compounds. Examples of these compounds are, but is not limited to, ammonium citrate dibasic, ammonium citrate tribasic, ammonium hydrogencitrate, barium citrate tribasic heptahydrate, calcium citrate tribasic tetrahydrate, citric acid monohydrate, citric acid trisodium salt, iron(iii)citrate tribasic monohydrate, lead(ii)citrate tribasic trihydrate, lithium citrate hydrate, lithium citrate tribasic, lithium citrate tribasic tetrahydrate, magnesium citrate tribasic nonahydrate, potassium citrate monobasic, potassium citrate tribasic monohydrate, silver citrate hydrate, sodium citrate, sodium citrate dibasic sesquihydrate, sodium citrate dihydrate, sodium citrate monobasic, sodium citrate tribasic dihydrate, sodium citrate tribasic hydrate, sodium dihydrogencitrate, sodium hydrogencitrate sesquihydrate, zinc citrate dihydrate, and zinc citrate tribasic dihydrate.

The use and the method according to the present invention are useful for treating any household surface such as found in kitchens and bathrooms, including cooker tops, extractor fans, tiles, floors, baths, toilets, wash basins, showers, dishwashers, taps, sinks, work surfaces. These surfaces may, for example, be made of plastics, glass, enamel, ceramic, wood (painted, lacquered or otherwise) or metal (e.g. stainless steel or chrome). The use and method according to the present invention are especially useful for treating household surfaces where fatty soils are especially common, e.g. kitchen work surfaces, cabinets, cooker tops, extractor fans, tiles, sinks. The use and method according to the present invention are especially useful for treating household surface materials on which fatty soils are especially susceptible to ageing and toughening reactions and processes, e.g. hard surfaces in kitchens and surfaces associated with cooking. Examples of kitchen surfaces are stainless steel, chrome, vitreous enamel, vitroceramic, or ceramic tile.

The present invention may also deliver other benefits such as improved surface feel (e.g. smoothness) during and/or after cleaning, olfactory benefits (e.g. reduction in rancid odour) before cleaning, less surface corrosion and less noise during cleaning. Further aspects of the present invention comprise use of citric acid and/or a salt of citric acid for obtaining one or more of these other benefits in a hard surface cleaning operation and/or use of citric acid and/or a salt of citric acid in the manufacture of products for delivering one or more such other benefits. Furthermore, citric acid and the salts of citric acid do not discolour, which is a particular advantage for a cleaning method according to the invention.

Whilst not being bound by any particular theory or explanation, we believe that citric acid and/or a salt of citric acid exerts its effect by depositing on the surface, by interacting with the surface and exerting an influence on soil or stains subsequently depositing on the surface such that such soil or stains are prevented from getting strongly attached to that surface and are prevented from toughening and becoming difficult to clean.

Form of Utilisation

The invention provides the use of citric acid and/or a salt of citric acid for facilitating the removal of soil, in particular fatty soil, from a hard surface, wherein the surface is treated with citric acid and/or a salt of citric acid prior to deposition of the soil. Preferably citric acid and/or a salt of citric acid is applied to the surface as a solution, preferably an aqueous solution, which is thereafter left to dry on the surface.

Preferably the soil or stain is a fatty soil or stain, or a soil or stain containing fatty material, that has undergone a toughening reaction. Accordingly in a preferred embodiment the invention provides the use of citric acid and/or a salt of citric acid for facilitating the removal of soil, in particular fatty soil, from a hard surface, wherein the surface is treated with citric acid and/or a salt of citric acid prior to deposition and toughening of the soil.

Citric acid and/or a salt of citric acid is preferably applied to the surface in the form of a composition containing citric acid and/or a salt of citric acid or by means of a wipe impregnated with citric acid and/or a salt of citric acid or with a composition containing citric acid and/or a salt of citric acid.

Hard Surface Treatment Compositions

Citric acid and/or a salt of citric acid can be employed according to the present invention in any suitable composition.

The composition must be suitable for depositing citric acid and/or a salt of citric acid material onto a hard surface. Citric acid and/or a salt of citric acid may be present in the composition in any suitable form, for example in the form of a solution or dispersion. Except where expressed or implied to the contrary, the component may also be in solid form, to be wetted upon use. However, in preferred embodiments they are liquids. The term ‘liquid’ includes solutions, dispersions, emulsions, gels, pastes and the like. In liquid form, they preferably have a pH between 2 and 13.

Suitable liquid compositions include solutions, dispersions or emulsions in a liquid carrier, which may be an organic solvent or water or a combination thereof. Preferably the solvent is predominantly (i.e. 50% or more) water. The compositions may be used only to deposit citric acid and/or a salt of citric acid, or they may have additional functions such as cleaning. In a preferred embodiment the first aspect of the invention provides the use of citric acid and/or a salt of citric acid in a composition comprising a detergent surfactant at a concentration between 0.01 to 50% by weight, and citric acid and/or a salt of citric acid at a concentration between 0.05% by weight and 10% by weight, preferably between 0.05 and 5% by weight, more preferably between 0.05 and 2% by weight.

If said liquid composition will be applied in the method according to the invention, and a rinsing step will be applied after treating the surface with citric acid and/or a salt of citric acid, then the required amount of citric acid and/or salt of citric acid will be relatively high as compared to a composition that will be used in the method according to the invention without rinsing step. A sufficient amount of citric acid and/or salt of citric acid should be deposited on the hard surface prior to deposition of the soil, in order to obtain the next time cleaning benefit. If a rinsing step is applied, then typically water is used as the rinsing medium.

Accordingly in a preferred embodiment the invention provides use of citric acid and/or a salt of citric acid, wherein citric acid and/or a salt of citric acid is comprised in a composition at a concentration between 0.05% by weight and 2% by weight, and wherein no rinsing step is applied after the surface has been treated with citric acid and/or a salt of citric acid. More preferred said composition comprises citric acid and/or a salt of citric acid at a concentration between 0.05% by weight and 1% by weight.

In another preferred embodiment the invention provides use of citric acid and/or a salt of citric acid, wherein citric acid and/or a salt of citric acid is comprised in a composition at a concentration between 0.25% by weight and 10% by weight, and wherein a rinsing step is applied after the surface has been treated with citric acid and/or a salt of citric acid and before deposition of the soil. More preferred said composition comprises citric acid and/or a salt of citric acid at a concentration between 1% by weight and 10% by weight.

When using citric acid and/or a salt of citric acid in such a composition, the composition may be applied by any suitable means in diluted or concentrated form. For example, it can be poured or sprayed onto the surface from a container or from an aerosol can or from a spray gun applicator. Alternatively it may be applied using a cloth, wipe or other implement which has been wetted with the composition.

Said compositions may include ingredients well known for use in hard surface cleaning compositions. In a preferred embodiment the invention provides the use of citric acid and/or a salt of citric acid in a composition comprising a detergent surfactant at a concentration between 0.01 to 50% by weight, and citric acid and/or a salt of citric acid at a concentration between 0.05% by weight and 10% by weight. Said compositions optionally comprise other hard surface cleaning components.

It is especially preferred that the composition is a ‘liquid’. Compositions can be water-thin or have a viscosity of at least 50 mPa·s as measured at a shear rate of 21 s⁻¹ at room temperature (using Haake Model RT20 viscometer), but preferably no more than 5,000 mPa·s. This viscous liquid composition may be in the form of a viscous liquid per se, or a gel, foam, mousse or paste. The viscosity may be due to one or more other components in the system, for example an ‘external polymeric thickener’, which may be a synthetic polymer, e.g. of the polycarboxylate type such as Carbopol™, or a natural polysaccharide gum such as xanthan gum or guar gum. Alternatively, an ‘internal structuring’ system may be used, employing one or more surfactants and optionally electrolyte, to create an ordered or liquid crystalline phase within the composition. These various techniques for increasing viscosity are all very well known to those skilled in the art.

Foams and mousses are normally supplied from a dispenser which gassifies or aerates the product that is dispensed therefrom.

Surfactants

In a preferred embodiment the invention provides use of citric acid and/or a salt of citric acid in a composition comprising a detergent surfactant at a concentration between 0.01 to 50% by weight. Said surfactant (detergent actives) are generally chosen from both anionic and nonionic detergent actives. The composition may further comprise cationic, amphoteric and zwitterionic surfactants. In surfactant-containing compositions of the present invention, the total amount of surfactant to be employed will generally be from 0.01 to 50%. Preferably, the amount is at least 0.1%, more preferably at least 0.5%, still more preferably at least 1%. The maximum amount is usually 30% or less, preferably not more than 20%, or even at or below 10%.

If said liquid composition will be applied in the method or use according to the invention, and no rinsing step will be applied after treating the surface with citric acid and/or a salt of citric acid, then the required amount of surfactant may advantageously be relatively low as compared to a composition that will be used in the method according to the invention with a rinsing step. Such liquid compositions with relatively lower amounts of surfactant can provide better residues and end-results performance, without jeopardising the next time cleaning benefit. Said residues are surfactants and other solid components of the cleaning composition.

Suitable synthetic (non-soap) anionic surfactants are water-soluble salts of organic sulphuric acid mono-esters and sulphonic acids which have in the molecular structure a branched or straight chain alkyl group containing from 6 to 22 carbon atoms in the alkyl part.

Examples of such anionic surfactants are water soluble salts of:
(primary) long chain (e.g. 6-22 C-atoms) alcohol sulphates (hereinafter referred to as PAS), especially those obtained by sulphating the fatty alcohols produced by reducing the glycerides of tallow or coconut oil;
alkyl benzene sulphonates, such as those in which the alkyl group contains from 6 to 20 carbon atoms;
secondary alkanesulphonates;

and mixtures thereof.

Also suitable are the salts of:
alkylglyceryl ether sulphates, especially of the ethers of fatty alcohols derived from tallow and coconut oil;
fatty acid monoglyceride sulphates;
sulphates of ethoxylated aliphatic alcohols containing 1-12 ethyleneoxy groups;
alkylphenol ethylenoxy-ether sulphates with from 1 to 8 ethyleneoxy units per molecule and in which the alkyl groups contain from 4 to 14 carbon atoms;
the reaction product of fatty acids esterified with isethionic acid and neutralised with alkali,

and mixtures thereof.

The preferred water-soluble synthetic anionic surfactants are the alkali metal (such as sodium and potassium) and alkaline earth metal (such as calcium and magnesium) salts of alkyl-benzenesulphonates and mixtures with olefinsulphonates and alkyl sulphates, and the fatty acid mono-glyceride sulphates.

The most preferred anionic surfactants are alkyl-aromatic sulphonates such as alkylbenzenesulphonates containing from 6 to 20 carbon atoms in the alkyl group in a straight or branched chain, particular examples of which are sodium salts of alkylbenzenesulphonates or of alkyl-toluene-, -xylene- or -phenolsulphonates, alkylnaphthalene-sulphonates, ammonium diamylnaphthalene-sulphonate, and sodium dinonyl-naphthalene- sulphonate.

If synthetic anionic surfactant is to be employed the amount present in the compositions of the invention will generally be at least 0.1%, preferably at least 0.5%, more preferably at least 1.0%, but not more than 20%, preferably at most 15%, more preferably at most 10%.

A suitable class of nonionic surfactants can be broadly described as compounds produced by the condensation of simple alkylene oxides, which are hydrophilic in nature, with an aliphatic or alkyl-aromatic hydrophobic compound having a reactive hydrogen atom. The length of the hydrophilic or polyoxyalkylene chain which is attached to any particular hydrophobic group can be readily adjusted to yield a compound having the desired balance between hydrophilic and hydrophobic elements. This enables the choice of nonionic surfactants with the right HLB. Particular examples include:
the condensation products of aliphatic alcohols having from 8 to 22 carbon atoms in either straight or branched chain configuration with ethylene oxide, such as a coconut alcohol/ethylene oxide condensates having from 2 to 15 moles of ethylene oxide per mole of coconut alcohol;
condensates of alkylphenols having C6-C15 alkyl groups with 5 to 25 moles of ethylene oxide per mole of alkylphenol;
condensates of the reaction product of ethylene-diamine and propylene oxide with ethylene oxide, the condensates containing from 40 to 80% of ethyleneoxy groups by weight and having a molecular weight of from 5,000 to 11,000.

Other classes of nonionic surfactants are:
alkyl polyglycosides, which are condensation products of long chain aliphatic alcohols and saccharides;
tertiary amine oxides of structure R¹R²R³N—O, where R¹ is an alkyl group of 8 to 20 carbon atoms and R² and R³ are each alkyl or hydroxyalkyl groups of 1 to 3 carbon atoms, e.g. dimethyldodecylamine oxide;
tertiary phosphine oxides of structure R¹R²R³P—O, where R¹ is an alkyl group of 8 to 20 carbon atoms and R² and R³ are each alkyl or hydroxyalkyl groups of 1 to 3 carbon atoms, for instance dimethyl-dodecylphosphine oxide;
dialkyl sulphoxides of structure R¹R²S═O, where R¹ is an alkyl group of from 10 to 18 carbon atoms and R² is methyl or ethyl, for instance methyl-tetradecyl sulphoxide;
fatty acid alkylolamides, such as the ethanol amides;
alkylene oxide condensates of fatty acid alkylolamides;
alkyl mercaptans.

In a preferred embodiment the invention provides use of citric acid and/or a salt of citric acid in a composition wherein the nonionic surfactant is present in a concentration of less than 25% by weight. The concentration of nonionic surfactant to be employed in said cleaning composition of the invention will preferably be at least 0.1%, more preferably at least 0.5%, most preferably at least 1%. The amount is suitably at most 20%, preferably not more than 15% and most preferably not more than 10%.

The compositions may contain amounts of both anionic and nonionic surfactants which are chosen, bearing in mind the level of electrolyte if present, so as to provide a structured liquid detergent composition, i.e. one which is ‘self-thickened’. Thus, in spite of the presence of organic solvent, thickened liquid cleaning compositions can be made without the need to employ any additional thickening agent and which nevertheless have a long shelf life over a wide temperature range.

The weight ratio of anionic surfactant to nonionic surfactant may vary, taking the above considerations in mind, and will depend on their nature, but in a preferred embodiment the first aspect of the invention provides use of citric acid and/or a salt of citric acid in a composition wherein the detergent surfactant comprises anionic and nonionic surfactants in a ratio between 20:1 and 1:10, more preferably from 15:1 to 1:5, and ideally above 10:1 to 1:2.

According to an embodiment illustrating any aspect of the invention, the compositions may comprise from 0.05% to 10% by weight of citric acid and/or a salt of citric acid, from 0 to 20%, preferably from 0.5% to 10% by weight of water-soluble, synthetic anionic sulphate or sulphonate surfactant salt containing an alkyl radical having from 8 to 22 carbon atoms in the molecule, and from 0.5 to 10% by weight of ethoxylated nonionic surfactant derived from the condensation of an aliphatic alcohol having from 8 to 22 carbon atoms in the molecule with ethylene oxide, such that the condensate has from 2 to 15 moles of ethylene oxide per mole of aliphatic alcohol, the balance being other optional ingredients and water.

It is also possible optionally to include amphoteric, cationic or zwitterionic surfactants in said compositions.

Suitable amphoteric surfactants are derivatives of aliphatic secondary and tertiary amines containing an alkyl group of 8 to 20 carbon atoms and an aliphatic group substituted by an anionic water-solubilising group, for instance sodium 3-dodecylamino-propionate, sodium 3-dodecylaminopropane-sulphonate and sodium N-2-hydroxy-dodecyl-N-methyltaurate.

Examples of suitable cationic surfactants can be found among quaternary ammonium salts having one or two alkyl or aralkyl groups of from 8 to 20 carbon atoms and two or three small aliphatic (e.g. methyl) groups, for instance cetyltrimethylammonium chloride.

A specific group of surfactants are the tertiary amines obtained by condensation of ethylene and/or propylene oxide with long chain aliphatic amines. The compounds behave like nonionic surfactants in alkaline medium and like cationic surfactants in acid medium.

Examples of suitable zwitterionic surfactants can be found among derivatives of aliphatic quaternary ammonium, sulphonium and phosphonium compounds having an aliphatic group of from 8 to 18 carbon atoms and an aliphatic group substituted by an anionic water-solubilising group, for instance betaine and betaine derivatives such as alkyl betaine, in particular C₁₂-C₁₆ alkyl betaine, 3-(N,N-dimethyl-N-hexadecylammonium)-propane-1-sulphonate betaine, 3-(dodecylmethyl-sulphonium)-propane-1-sulphonate betaine, 3-(cetylmethyl-phosphonium)-propane-1-sulphonate betaine and N,N-dimethyl-N-dodecyl-glycine. Other well known betaines are the alkylamidopropyl betaines e.g. those wherein the alkylamido group is derived from coconut oil fatty acids.

Further examples of suitable surfactants are compounds commonly used as surface-active agents given in the well-known textbooks: ‘Surface Active Agents’ Vol. 1, by Schwartz & Perry, Interscience 1949; ‘Surface Active Agents’ Vol. 2 by Schwartz, Perry & Berch, Interscience 1958; the current edition of ‘McCutcheon's Emulsifiers and Detergents’ published by Manufacturing Confectioners Company; ‘Tenside-Taschenbuch’, H. Stache, 2nd Edn., Carl Hauser Verlag, 1981.

pH

In the first aspect the invention provides the use of citric acid and/or a salt of citric acid for facilitating the removal of soil, in particular fatty soil, from a hard surface. In a preferred embodiment the citric acid and/or a salt of citric acid are comprised in a composition having a pH of from 2 to 13, more preferably at least 3, and not more than 12.5, preferably not less than 3.5, more preferably not more than 12. Compositions intended for cleaning kitchen hard surfaces may advantageously have a pH in the alkaline range, while bathroom cleaners preferably have a pH in the acidic range. Preferably the composition either has a pH between 8.5 and 12, more preferred between 10 and 11.5, or between 3 and 6.5, more preferred between 3 and 5. Suitably the composition has a pH of at least 6.5, more suitably between 6.5 and 12.5, even more suitably between 7 and 11, and most suitably between 8 and 9.5.

The pH of the solution may be adjusted with organic or inorganic acids or bases. Preferred inorganic bases are preferably alkali or alkaline earth hydroxides, ammonia, carbonates or bicarbonates. The alkali metal preferably being sodium or potassium or the alkaline earth metal preferably being calcium or magnesium. The organic bases are preferably amines, alkanolamines and other suitable amino compounds. Inorganic acids may include hydrochloric acid, sulphuric acid or phosphoric acid, and organic acids may include acetic acid, or formic acid as well as dicarboxilic acid mixtures such as Radimix (trade mark, Radici Group) and Sokalan DCS (trade mark, BASF).

Other Optional Ingredients

The compositions according to the present invention may include abrasives. However, these are generally not preferred as abrasives tend to damage or remove the thin layer of citric acid and/or a salt of citric acid being deposited on the surface. In a preferred embodiment the composition according to the present invention does not contain an abrasive. The compositions may contain other ingredients which aid in their cleaning performance. For example, they may contain detergent builders and mixtures of builders in an amount of up to 25%, in particular when the composition contains one or more anionic surfactants. Some of these builders can additionally function as abrasives if present in an amount in excess of their solubility in water. If present, the builder preferably will form at least 0.1% of the composition. Suitable inorganic and organic builders are well known to those skilled in the art.

A further optional ingredient for compositions according to the invention is a suds regulating material, which can be employed in compositions which have a tendency to produce excessive suds in use. Examples thereof are fatty acids or their salts (soap), isoparaffins, silicone oils and combinations thereof.

Soaps are salts of fatty acids and include alkali metal soaps such as the sodium, potassium and ammonium salts of fatty acids containing from about 8 to about 24 carbon atoms, and preferably from about 10 to about 20 carbon atoms. Particularly useful are the sodium and potassium and mono-, di- and triethanolamine salts of the mixtures of fatty acids derived from palm oil, coconut oil and ground nut oil. When employed, the amount of fatty acid or soap can form at least 0.005%, preferably 0.1% to 2% by weight of the composition.

Where a hydrocarbon co-solvent is present at a sufficiently high level this may itself provide some or all of the required antifoaming activity.

Compositions may also contain, in addition to the ingredients already mentioned, various other optional ingredients such as colourants, whiteners, optical brighteners, soil suspending agents, detersive enzymes, compatible bleaching agents (particularly peroxide compounds and active chlorine releasing compounds), gel-control agents, further freeze-thaw stabilisers, bactericides, preservatives (for example 1,2-benzisothiazolin-3-one), hydrotropes and perfumes.

In a preferred embodiment the composition of the present invention does not comprise tannic acid or derivatives of tannic acid such as gallic acid and/or propyl gallate. It was found that when tannic acid is formulated into alkaline liquid cleaning compositions it produces aesthetically less-pleasing yellow-brown coloured solutions, and it may lead to browning of cement in joints between tiles.

In another preferred embodiment the composition of the present invention does not comprise malonic acid. An antioxidant like malonic acid needs relatively high concentrations to achieve a next time cleaning benefit. Moreover consumers may regard residues of malonic acid on the hard surfaces in e.g. kitchen and bathroom to be harmful and undesired.

In yet another preferred embodiment the composition of the present invention does not comprise formic acid. Formic acid has a pungent odour, and residues on hard surfaces are aesthetically undesirable.

Polymers

In a preferred embodiment the first aspect of the invention provides the use of citric acid and/or a salt of citric acid in a composition wherein the composition further comprises a polymer, and wherein the polymer to citric acid and/or salt of citric acid ratio (by weight) is in the range of 0.1:1 to 2:1. In particular polymers are preferred that aid the binding of citric acid and/or salt of citric acid to the surface and thus providing additional rinse resistance, if a rinsing step is applied after treating the surface with citric acid and/or a salt of citric acid in the method according to the invention. Preferred polymers are nonionic and anionic polymers.

Polymer to Citric Acid and/or Salt of Citric Acid Ratio

For optimal benefits, the polymer to citric acid and/or a salt of citric acid ratio (by weight) should be in the range 0.1:1 to 2:1, preferably in the range 0.2:1 to 1:1, most preferably in the range 0.3:1 to 0.8:1.

Preferred polymers are those polymers having an average molecular weight above 4,000 Dalton. More preferably the molecular weight is at least 10,000 D, even more preferably above 100,000 D or even above 1,000,000 D. The polymers normally have a molecular weight below 5,000,000 Dalton, preferably below 4,000,000 D.

Suitable polymers are either water-soluble or water-dispersible, preferably water-soluble.

Non-Ionic Polymer

The non-ionic polymer may be chosen from cellulose-based nonionic polymers such as celluloses, alkylcelluloses, hydroxyalkylcelluloses, cellulose ethers, cellulose esters and cellulose amides, such as methylcellulose, ethylcellulose, hydroxymethylcellulose, hydroxypropylcellulose, hydroxypropylmethylcellulose. Other polysaccharide polymers, such as starches and modified starches, and dextrins, such as maltodextrin, are also suitable.

Furthermore, the non-ionic polymer may be chosen from fully synthetic polymers such as polyvinyl alcohols, polyvinylpyrrolidones, polyalkylene glycols such as polyethylene glycol, polyalkylene oxides, polyamides, polyacrylamides, polyvinylethers such as polymethylvinylether, polyvinyl acetates, and copolymers thereof.

Polyacrylic acids, polymethacrylic acids and their homologues, and other polycarboxylic acids may also be used in compositions where the polymers behave as nonionic polymers. Such compositions are typically acidic compositions with pH values below about 4.

Most preferably the non-ionic polymer is selected from polyvinyl pyrrolidone (PVP), polyvinyl alcohol (PVA) and combinations thereof. The PVP includes substituted and unsubstituted vinyl pyrrolidone polymerization products.

Preferably said compositions comprise at least 0.1%, more preferably at least 0.2% by weight non-ionic polymer and at most 10%, preferably at most 5%, more preferably at most 2%.

Anionic Polymer

Preferred anionic polymers are water soluble anionic polymers. Suitable polymers are mainly synthetic, but natural or nature-derived polymers may also be used. Suitable polymers include polyacrylic acids and polymethacrylic acids and their homologues, other polycarboxylic acids, polyaminoacids or peptides, polyanhydrides, polystyrene sulphonic acids, polyvinylsulfonic acids, and their copolymers and their copolymers with nonionic monomers and polymers. Natural gums, such as xanthan, locust bean and carrageenans, and cellulose derivatives, such as carboxymethylcellulose, may also be suitable.

As mentioned herein, some anionic polymers may behave as non-ionic polymers at acidic pHs.

If anionic polymers are present, the compositions preferably comprise at least 0.1%, more preferably at least 0.2% by weight anionic polymer and at most 10%, preferably at most 5%, more preferably at most 2%.

Liquid Dispensers

Liquid compositions may be stored in and dispensed by any suitable means, but spray applicators are particularly preferred. Pump dispensers (whether spray or non-spray pumps) and pouring applicators (bottles etc) are also possible. Thus, in a preferred embodiment the first aspect of the invention provides the use of citric acid and/or a salt of citric acid in a composition, wherein the composition comprising citric acid and/or a salt of citric acid is comprised in a reservoir in a container, wherein the container further comprises a spray dispenser for dispensing said composition in the form of a spray. The spray dispenser is preferably a trigger spray but may be any mechanical means for ejecting the liquid in spray or aerosol form.

Wipes

Wipes can be impregnated with neat citric acid and/or a salt of citric acid or with a composition containing citric acid and/or a salt of citric acid. The material may be impregnated dry, or more preferably in wet form (i.e. as a thin or a viscous liquid). Suitable wipes include woven or nonwoven cloths, natural or synthetic sponges or spongy sheets, ‘squeegee’ materials and the like.

In a preferred embodiment the invention provides use of citric acid and/or a salt of citric acid, wherein a wipe is impregnated with a composition comprising citric acid and/or a salt of citric acid. The composition can be any composition as preferred elsewhere in this specification.

Method of the Invention

In a second aspect the present invention provides a method for removing soil or stains from a hard surface, the method comprising the sequential steps:
a) treating the surface with a composition comprising citric acid and/or a salt of citric acid at a concentration of between 0.05 wt % and 10 wt %.
b) allowing the soil or stain to deposit and toughen; and
c) cleaning the surface to remove the soil or stains.

Preferably the soil or stain is a fatty soil or stain, or a soil or stain containing fatty material, that has undergone a toughening reaction. The soil or stain experiences toughening reactions and processes after having been deposited on the surface, and therewith requires more effort to clean. Without wishing to be bound by theory, toughening can arise from the effects of drying out of soils, from chemical changes in soils, from reactions of soils with environmental agents such as oxygen, etc. Some soils are more susceptible than others to toughening reactions and processes. Soils comprising or containing chemically unsaturated oils and fats can become very tough and difficult to clean over time, especially when exposed to elevated temperatures. Even light can cause such fatty soils to toughen over time. As well as environmental factors, the processes of toughening of soils can be affected by the nature and composition of the surface on which the soil is located.

Step (c) of the method is advantageously effected using a hard surface cleaning composition comprising citric acid and/or a salt of citric acid again so that soil or stain is removed and new citric acid and/or salt of citric acid is applied, effectively constituting step (a) of a subsequent process according to the second aspect of the invention.

If a rinsing step is applied after treating the surface with citric acid and/or a salt of citric acid according to the method of the invention, the required amount of citric acid and/or salt of citric acid in the composition will be higher than when no rinsing step is applied after treating the surface with citric acid and/or a salt of citric acid. Accordingly in a preferred embodiment of the second aspect, the invention provides a method for removing soil or stains from a hard surface, wherein said composition comprises citric acid and/or a salt of citric acid at a concentration of between 0.05% by weight and 2% by weight, and wherein no rinsing step is applied after treating the surface with said composition. More preferred said composition comprises citric acid and/or a salt of citric acid at a concentration between 0.05% by weight and 1% by weight.

In another preferred embodiment of the second aspect, the invention provides a method for removing soil or stains from a hard surface, wherein the composition comprises citric acid and/or a salt of citric acid at a concentration of between 0.25% by weight and 10% by weight, and wherein a rinsing step is applied after treating the surface with said composition. More preferred said composition comprises citric acid and/or a salt of citric acid at a concentration between 1% by weight and 10% by weight.

Use of Citrate as Cleaning Aid for Hard Surfaces

### Examples

The following non-limiting examples further illustrate the present invention.

### Example 1

Method for Assessing Contribution of Various Complexing Agents to Easier Cleaning of Toughened Dehydrated Castor Oil (DHCO) Soil

The basic steps in the methodology are:
Pre-cleaning of test piece surface
Treatment of surface with test solution
Application of a film of DHCO soil on treated surface
Heat treatment of surface to induce oxidative toughening of DHCO soil
Cleaning of soiled surface under standard scrubbing conditions, using Abrasion Tester apparatus
Expression of cleaning results (% soil removal), based on gravimetric analysis of soiled versus cleaned surface

Test Surface

Treatments are evaluated on 10.0×10.0 cm pieces of 304 grade brushed stainless steel. Test pieces are previously unused, and are pre-cleaned prior to use.

Pre-Cleaning of Stainless Steel Test Surfaces

Test pieces are soaked for at least 1 hour in ˜17% by weight potassium hydroxide in 50/50% by weight aqueous methylated spirits to remove any surface contamination from the metal-working process, which might influence wetting of the surface by the test treatment or DHCO soil. After soaking, surfaces are thoroughly rinsed in running tap water and allowed to dry naturally in air, stored vertically.

### Test Solutions

### Example 1

Test agents are examined in the following 7 simple detergent base solutions. Solutions A, B, and C are according to the invention, and solutions D, E, F, and G are comparative solutions.

TABLE 1
Formulations of example 1

| | | | | D | E | F | G |
|---|---|---|---|---|---|---|---|
| | A | B | C | (comp.) | (comp.) | (comp.) | (comp.) |
| nonionic | 5 | 5 | 5 | 5 | 5 | 5 | 5 |
| surfactant | | | | | | | |
| Neodol 91-8 | | | | | | | |
| (Shell | | | | | | | |
| Chemicals) | | | | | | | |
| [wt %] | | | | | | | |
| citric acid [wt %] | 0.2 | 0.5 | 0.8 | 0 | 0 | 0 | 0 |
| di-sodium | 0 | 0 | 0 | 0.2 | 0.5 | 0.8 | 0 |
| malonate | | | | | | | |
| monohydrate | | | | | | | |
| [wt %] | | | | | | | |
| water | to 100% | to 100% | to 100% | to 100% | to 100% | to 100% | to 100% |
| pH of the | 10 | 10 | 10 | 10 | 10 | 10 | 10 |
| solution* | | | | | | | |
| corresponding | 0.010 | 0.026 | 0.041 | 0.012 | 0.030 | 0.048 | 0 |
| molar | | | | | | | |
| concentration of | | | | | | | |
| additive [mole/L] | | | | | | | |

*adjusted with sodium hydroxide or hydrochloric acid

Treatment of Surfaces

The stainless steel tile is pre-weighed (to 4 decimal places). A 5.0×5.0 cm area in the centre of the stainless steel surface is marked out by a square of adhesive masking tape. 0.01 ml of test solution is applied to the central 25 cm² area of surface and distributed uniformly over the area using a glass spreader. The treatment is allowed to dry naturally.

Soiling of Surfaces

0.040 gram (+/−4 mg) of DHCO (John L Seaton & Co, Humberside, UK) is applied to the central templated area of the treated surface and distributed over the 25 cm² area of surface using a purpose-made spreader, to produce an even film of oil. The masking tape template is carefully removed and the soiled tile is reweighed.

Oxidative Toughening of DHCO Soil

To simulate the oxidative toughening that an unsaturated oil might experience on a cooker top, test surfaces are heated in an oven at 100° C. for 60 minutes. Test surfaces are allowed to cool and equilibrate for at least 1 hour. The test surface is reweighed and the weight of aged oil (Wᵢₙᵢₜᵢₐₗ) calculated.

Cleaning

Cleaning is carried out in a Martindale Abrasion Tester apparatus (SDL International) over one full lissajous figure (16 cycles) using a 1.5 cm diameter circle of non-woven cleaning cloth (‘Ballerina’, Unilever) attached to the cleaning head. By each full lissajous figure, the entire surface of the tile is cleaned once. The head has a total mass of 994 gram, applying a cleaning force of about 560 gram/cm² to the soiled test surface. Cleaning is carried out using a simple detergent base (5.0% Neodol 91-8, adjusted to pH 10).

The soiled tile is fixed centrally in the abrasion tester's sample well and 20.0 gram cleaning product is introduced. Immediately, the cleaning head is secured in place and the Abrasion Tester apparatus run for one full lissajous figure. The cleaned tile is removed and rinsed free from cleaning product and any loose soil under a running tap. The surface is allowed to dry, stored vertically, and then reweighed. The weight of any remaining DHCO soil (W_{final}) is calculated.

Calculation of Results

Cleaning performance is expressed as % Soil Removal, derived from the weights of the tiles at the different stages in the method:

$$Soil Removal ( \% ) = \frac{{W}_{initial} - {W}_{final}}{{W}_{initial}} \cdot 100 \%$$

where Wᵢₙᵢₜᵢₐₗ=weight of initial DHCO, before cleaning
W_{final}=weight of residual DHCO, after cleaning

### Cleaning Results

### Example 1

The cleaning results of the 7 test solutions are the following. Solutions A, B, and C are according to the invention, and solutions D, E, F, and G are comparative solutions.

TABLE 2
Cleaning results of example 1

| | | | | D | E | F | G |
|---|---|---|---|---|---|---|---|
| | A | B | C | (comp.) | (comp.) | (comp.) | (comp.) |
| soil removal | 95.4 | 99.2 | 95.8 | 24.6 | 74.6 | 79.1 | 1.0 |
| [%] | | | | | | | |

Already at a concentration of 0.2% by weight in the cleaning composition, citric acid exhibits a strong next time cleaning benefit.

### Example 2

A further Test was carried out according to the same procedures detailed for Example 1.

### Test Solutions

### Example 2

Test agents are examined in the following 7 simple detergent base solutions. Solutions K, L, M and N are according to the invention, and solutions H, I and J are comparative solutions.

TABLE 3
Formulations of example 2

| | H | I | J | | | | |
|---|---|---|---|---|---|---|---|
| | (comp.) | (comp.) | (comp.) | K | L | M | N |
| nonionic | 5 | 5 | 5 | 5 | 5 | 0 | 0 |
| surfactant | | | | | | | |
| Neodol 91-8 | | | | | | | |
| (Shell | | | | | | | |
| Chemicals) | | | | | | | |
| [wt %] | | | | | | | |
| anionic | 0 | 0 | 0 | 0 | 0 | 5 | 5 |
| surfactant | | | | | | | |
| Empicol LX28 | | | | | | | |
| (Huntsman) | | | | | | | |
| [wt %] | | | | | | | |
| citric acid | 0 | 0 | 0 | 0.5 | 0.8 | 0.2 | 0.5 |
| [wt %] | | | | | | | |
| malonic acid | 0.5 | 0.8 | 0 | 0 | 0 | 0 | 0 |
| [wt %] | | | | | | | |
| water | to | to | to | to | to | to | to |
| | 100% | 100% | 100% | 100% | 100% | 100% | 100% |
| pH of the | 4 | 4 | 4 | 4 | 4 | 10 | 10 |
| solution* | | | | | | | |

*adjusted with sodium hydroxide or hydrochloric acid

### Cleaning Results

### Example 2

The cleaning results of the 7 test solutions are the following. Solutions K, L, M and N are according to the invention, and solutions H, I and J are comparative solutions.

TABLE 4
Cleaning results of example 2

| | H | I | J | | | | |
|---|---|---|---|---|---|---|---|
| | (comp.) | (comp.) | (comp.) | K | L | M | N |
| soil removal | 14.3 | 50.0 | 0 | 65.9 | 83.6 | 82.4 | 97.2 |
| [%] | | | | | | | |

For test solutions H-L, cleaning using the Martindale Abrasion Tester apparatus is carried out using a simple nonionic surfactant detergent base (5.0% Neodol 91-8, adjusted to pH 4). For test solutions M & N, cleaning is carried out using an anionic surfactant base (5.0% Empicol LX28, adjusted to pH 10).

Citric acid exhibits a stronger next time cleaning benefit than the prior art material malonic acid. The next time cleaning benefit of citric acid is delivered in anionic detergent solutions.

### Example 3

The effect of rinsing a surface treated with test solution prior to soiling with DHCO soil upon the next time cleaning benefit of citric acid is examined. A wiping protocol is used to simulate the common consumer practice of wiping a surface with a water-rinsed cloth after cleaning with a detergent solution.

Besides the introduction of a wipe rinsing protocol, this Test was carried out according to the same procedures detailed for Example 1.

### Test Solutions

### Example 3

Test agents are examined in the following 4 simple detergent base solutions. Solutions O, P and Q are according to the invention, and solution R is a comparative solution.

TABLE 5
Formulations of example 3

| | | | | R |
|---|---|---|---|---|
| | O | P | Q | (comp.) |
| nonionic surfactant | 5 | 5 | 5 | 5 |
| Neodol 91-8 (Shell | | | | |
| Chemicals) [wt %] | | | | |
| citric acid [wt %] | 0.8 | 2 | 5 | 0 |
| water | to | to | to | to |
| | 100% | 100% | 100% | 100% |
| pH of the solution * | 10 | 10 | 10 | 10 |

* adjusted with sodium hydroxide or hydrochloric acid

Wipe Rinsing of Surfaces

The stainless steel tile is treated with test solution according to the procedure outlined for Example 1. The treatment is allowed to dry for 30 seconds. The treated surface is subjected to a standard wiping protocol with a non-woven cleaning cloth wetted with demin. water (5.0×5.0 cm area of ‘Ballerina’ cloth (Unilever), loaded with 3 gram water per gram cloth). The treated area of surface receives two passes of the cloth, the second pass at right angles to the first. The wiped surface is allowed to dry naturally before soiling with DHCO according to the procedure of Example 1. This wiping protocol simulates a wipe rinsing regime used by many consumers when cleaning household surfaces.

### Cleaning Results

### Example 3

The cleaning results of the 4 test solutions are the following. Solutions O, P and Q are according to the invention, and solution R is a comparative solution.

TABLE 6
Cleaning result of example 3

| | | | | R |
|---|---|---|---|---|
| | O | P | Q | (comp.) |
| soil removal [%] | 32.3 | 49.4 | 61.9 | 0 |

For test solutions O-R, cleaning using the Martindale Abrasion Tester apparatus is carried out using a simple nonionic surfactant detergent base (5.0% Neodol 91-8, adjusted to pH 10).

Although the next time cleaning benefit of citric acid is reduced by rinsing, a useful effect is still delivered.

1. Use of citric acid and/or a salt of citric acid for facilitating the removal of soil, in particular fatty soil, from a hard surface, wherein the surface is treated with citric acid and/or a salt of citric acid prior to deposition of the soil.

2. Use according to claim 1 wherein citric acid and/or salt of citric acid is applied to the surface in liquid diluted form.

3. Use of citric acid and/or a salt of citric acid according to claim 1 or 2, in a composition comprising a detergent surfactant at a concentration between 0.01 to 50% by weight, and citric acid and/or a salt of citric acid at a concentration between 0.05% by weight and 10% by weight.

4. Use according to claim 3, wherein the nonionic surfactant is present in a concentration of less than 25% by weight.

5. Use according to claim 3 or 4 wherein the composition has a pH of 2 to 13.

6. Use according to claim 5 wherein the composition has a pH of above 6.5.

7. Use according to any of claims 3 to 6 wherein the composition further comprises a polymer, and wherein the polymer to citric acid and/or salt of citric acid ratio (by weight) is in the range of 0.1:1 to 2:1.

8. Use according to any of claims 1 to 7 wherein citric acid and/or a salt of citric acid is comprised in a composition that does not comprise malonic acid.

9. Use according to any of claims 1 to 8 wherein citric acid and/or a salt of citric acid is comprised in a composition that does not comprise tannic acid or a derivative thereof.

10. Use according to any of claims 1 to 9 wherein citric acid and/or a salt of citric acid is comprised in a composition that does not comprise an abrasive compound.

11. Use according to any of claims 1 to 10, wherein citric acid and/or a salt of citric acid is comprised in a composition at a concentration between 0.05% by weight and 2% by weight, and wherein no rinsing step is applied after the surface has been treated with citric acid and/or a salt of citric acid.

12. Use according to any of claims 1 to 10, wherein citric acid and/or a salt of citric acid is comprised in a composition at a concentration between 0.25% by weight and 10% by weight, and wherein a rinsing step is applied after the surface has been treated with citric acid and/or a salt of citric acid and before deposition of the soil.

13. Use according to any of claims 1 to 12, wherein a composition comprising citric acid and/or a salt of citric acid is comprised in a reservoir in a container, wherein the container further comprises a spray dispenser for dispensing said composition in the form of a spray.

14. Use according to any of claims 1 to 13, wherein a wipe is impregnated with a composition comprising citric acid and/or a salt of citric acid.

15. Use according to any of claims 1 to 14 for cleaning hard surfaces in kitchens and surfaces associated with cooking.

16. Use according to any of claims 1 to 15 for cleaning kitchen surfaces made of stainless steel, chrome, vitreous enamel, vitroceramic, or ceramic tile.

17. Use according to any of claims 1 to 16 for facilitating the removal of fatty soil.

18. A method for removing soil or stains from a hard surface, the method comprising the sequential steps:
a) treating the surface with a composition comprising citric acid and/or a salt of citric acid at a concentration of between 0.05% by weight and 10% by weight.
b) allowing the soil or stain to deposit and toughen; and
c) cleaning the surface to remove the soil or stains.

19. A method according to claim 18, wherein the composition comprises citric acid and/or a salt of citric acid at a concentration of between 0.05% by weight and 2% by weight, and wherein no rinsing step is applied after treating the surface with said composition.

20. A method according to claim 19, wherein the composition comprises citric acid and/or a salt of citric acid at a concentration of between 0.25% by weight and 10% by weight, and wherein a rinsing step is applied after treating the surface with said composition.

21. A method according to any of claims 18 to 20, wherein the composition has a pH of above 6.5.

22. A method according to any of claims 18 to 21, wherein the composition does not comprise tannic acid or a derivative thereof.

23. A method according to any of claims 18 to 22, wherein the composition does not comprise malonic acid.

24. A method according to any of claims 18 to 23, wherein the composition does not comprise an abrasive compound.

25. A method according to any of claims 18 to 24, wherein the soil or stain is a fatty soil or stain.
